(19) United States
(12) Patent Application Publication
(10) Pub. No.: US 2018/0063283 A1
(43) Pub. Date: Mar. 1, 2018

(54) INFORMATION PROCESSING APPARATUS, INFORMATION PROCESSING METHOD, AND PROGRAM

(71) Applicant: SONY CORPORATION, TOKYO (JP)

(72) Inventors: DAISUKE MOCHIZUKI, CHIBA (JP); SHOSUKE MOMOTANI, KANAGAWA (JP); NORIHIKO SATO, TOKYO (JP); YUYA HIRANO, TOKYO (JP)

(21) Appl. No.: 15/559,850

(22) PCT Filed: Feb. 2, 2016
(86) PCT No.: PCT/JP2016/053073

§ 371 Date: Sep. 20, 2017

(30) Foreign Application Priority Data
Mar. 30, 2015 (JP) 2015-068901

(51) Int. Cl. H04L 29/08; G06F 17/30

(52) U.S. Cl. CPC H04L 67/327; H04L 67/22; G06F 17/30528

(57) ABSTRACT

[Object] It is desirable to provide a technology which can realize either communication in which decrease of user-friendliness is suppressed or communication in which a sense of oneness can be easily obtained in accordance with a situation of a user.

[Solution] Provided is an information processing apparatus including an output control unit configured to control whether or not to perform delay processing of delaying output of first data transmitted from a terminal of a first user at a terminal of a second user, on the basis of a result of situation sensing with respect to the second user.

### TECHNICAL FIELD

The present disclosure relates to an information processing apparatus, an information processing method, and a program.

### BACKGROUND ART

In recent years, in accordance with development of an information communication technology, a technology for performing communication with other users using terminals is widely spread. Here, a technology for controlling a timing for starting communication with other users is known. For example, a technology for controlling a timing for starting communication with other users based on behavior of the other users is disclosed (see, for example, Patent Literature 1).

### CITATION LIST

### Patent Literature

Patent Literature 1: JP 2014-123192A

### DISCLOSURE OF INVENTION

### Technical Problem

However, it is desirable to provide a technology which can realize either communication in which decrease of user-friendliness is suppressed or communication in which a sense of oneness can be easily obtained in accordance with a situation of a user.

According to the present disclosure, there is provided an information processing apparatus including: a control unit configured to control whether or not to perform delay processing of delaying output at a terminal of a second user executed on the basis of first data transmitted from a terminal of a first user, on the basis of a result of situation sensing with respect to the second user.

According to the present disclosure, there is provided an information processing method including: controlling whether or not to perform delay processing of delaying output at a terminal of a second user executed on the basis of first data transmitted from a terminal of a first user, on the basis of a result of situation sensing with respect to the second user.

According to the present disclosure, there is provided a program causing a computer to function as an information processing apparatus including: a control unit configured to control whether or not to perform delay processing of delaying output at a terminal of a second user executed on the basis of first data transmitted from a terminal of a first user, on the basis of a result of situation sensing with respect to the second user.

### Advantageous Effects of Invention

As described above, according to the present disclosure, a technology is provided which can realize either communication in which decrease of user-friendliness is suppressed or communication in which a sense of oneness can be easily obtained in accordance with a situation of a user. Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram illustrating a configuration example of an information processing system according to an embodiment of the present disclosure.

FIG. 2 is a block diagram illustrating a functional configuration example of an information processing apparatus according to the embodiment.

FIG. 3 is a block diagram illustrating a functional configuration example of a terminal according to the embodiment.

FIG. 4 is a diagram illustrating an example of human relationship.

FIG. 5 is a diagram illustrating an example of a screen displayed by a terminal.

FIG. 6 explains a first operation example of sound data transmission/reception.

FIG. 7 explains a second operation example of sound data transmission/reception.

FIG. 8 is a diagram illustrating an example of a screen displayed by a terminal.

FIG. 9 is a diagram illustrating a display example of text data recognized from transmission/reception data.

FIG. 10 is a diagram illustrating a display example of a length of speech of a user for each speech segment recognized from the transmission/reception data.

FIG. 11 is a diagram illustrating a display example of a length of speech of each of a plurality of users belonging to a group.

FIG. 12 is a diagram illustrating another display example of the length of the speech of the user for each speech segment recognized from the transmission/reception data.

FIG. 13 is a diagram illustrating a display example of a topic or a keyword recognized from the transmission/reception data.

FIG. 14 is a diagram illustrating a display example of a degree of enthusiasm of conversation recognized from the transmission/reception data.

FIG. 15 is a diagram illustrating another display example of the degree of enthusiasm of conversation recognized from the transmission/reception data.

FIG. 16 is a diagram illustrating an example where, in the case where sound data is transmitted/received among the plurality of users belonging to a group, whether or not each user listens to the sound data is displayed.

FIG. 17 is a diagram illustrating a functional configuration example of a terminal in the case where haptic/tactile data is transmitted/received among terminals of the plurality of users.

FIG. 18 is a diagram illustrating an aspect where haptic/tactile data is transmitted/received to/from each other.

FIG. 19 is a block diagram illustrating a hardware configuration example of the information processing apparatus.

### MODE FOR CARRYING OUT THE INVENTION

Hereinafter, a preferred embodiment of the present disclosure will be described in detail with reference to the appended drawings. In this specification and the appended drawings, structural elements that have substantially the same function and structure are denoted with the same reference numerals, and repeated explanation of these structural elements is omitted.

Note that, in this description and the drawings, structural elements that have substantially the same function and structure are sometimes distinguished from each other using different numerals after the same reference sign. However, when there is no need in particular to distinguish structural elements that have substantially the same function and structure, the same reference sign alone is attached.

Note that description will be provided in the following order.

### 1. Embodiment of Present Disclosure

### 1.1. System Configuration Example

### 1.2. Functional Configuration Example

### 1.3. Details of Functions

### 1.4. Hardware Configuration Example

### 2. Conclusion

### 1. EMBODIMENT OF PRESENT DISCLOSURE

### 1.1. System Configuration Example

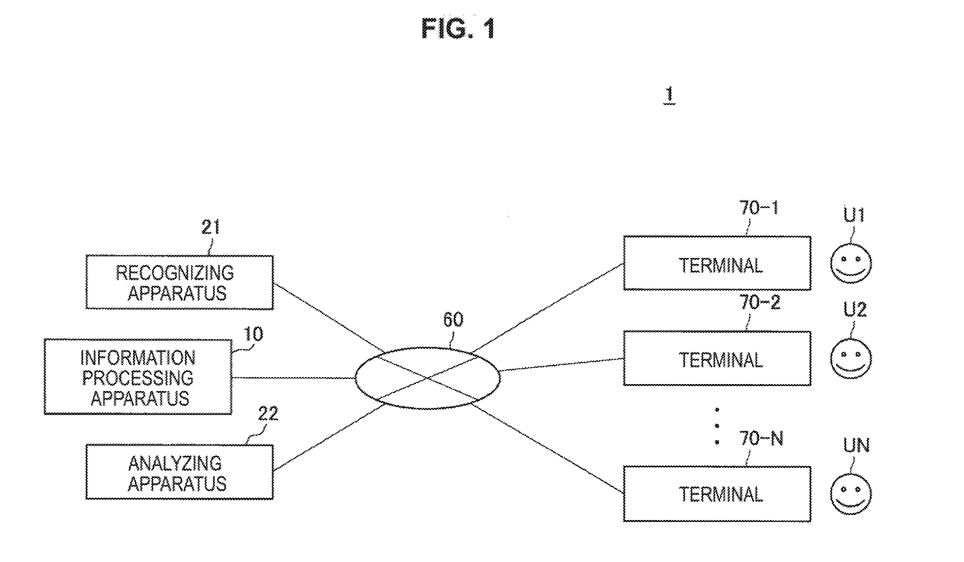

First, a configuration example of an information processing system according to an embodiment of the present disclosure will be described with reference to the drawings. FIG. 1 is a diagram illustrating a configuration example of an information processing system 1 according to the embodiment of the present disclosure. As illustrated in FIG. 1, the information processing system 1 according to the embodiment of the present disclosure includes an information processing apparatus 10, a recognizing apparatus 21, an analyzing apparatus 22, and terminals 70-1 to 70-N (where N is a natural number equal to or greater than 2).

The terminals 70-1 to 70-N are respectively utilized by corresponding users U1 to UN. While a case will be described as an example in the present specification where the terminals 70-1 to 70-N are wearable devices, the terminals 70-1 to 70-N are not limited to wearable devices. For example, the terminals 70-1 to 70-N may be personal computers (PCs), mobile phones, tablet PCs, personal digital assistants (PDAs), smartphones, or the like.

The recognizing apparatus 21 performs user state recognition operation as an example of operation for recognizing behavior of the respective users U1 to UN. More specifically, the recognizing apparatus 21 recognizes user states of the respective users U1 to UN based on sensor data detected by the terminals 70-1 to 70-N. Algorithm of user state recognition is not particularly limited. Further, a result obtained by the user state recognition is not particularly limited. For example, the result obtained by the user state recognition may be a location where the user exists. The location where the user exists may be name of a school building, a library, station, a store, facility, a building, office, or the like, or may be an area specified by address. Further, the result obtained by the user state recognition may be action of the user. The action of the user may be action such as walking, running, going up and down stairs, driving a car, shopping and working.

The analyzing apparatus 22 performs operation of analyzing conversation content as an example of operation for recognizing behavior of the respective users U1 to UN. More specifically, the analyzing apparatus 22 extracts information (such as, for example, a noun, a topic in conversation, or a keyword) appearing in conversation of the respective users U1 to UN as extracted information by analyzing conversation content of the respective users U1 to UN. A topic in conversation may be a form of a sentence such as “ . . . did . . . at . . . ”. Note that a method for analyzing conversation content is not limited. For example, in the case where the conversation content is character information, an extracted word can be extracted through language analysis such as morphological analysis from the conversation content.

The information processing apparatus 10 is an apparatus which performs various kinds of information processing. Here, a case will be assumed where communication is realized among a plurality of users. In such a case, there is a case where it cannot be said that user-friendliness is high depending on a situation of a reception side user in the case where data transmitted from a terminal of a transmission side user arrives at a terminal of the reception side user in real time. Meanwhile, if an output timing of data from the terminal of the reception side user is delayed until it becomes convenient for the reception side user, there is a possibility that communication in which a sense of oneness can be easily obtained cannot be realized.

Therefore, in the present specification, a technology will be mainly proposed which can realize either communication in which decrease of user-friendliness is suppressed or communication in which a sense of oneness can be easily obtained in accordance with a situation of a user. Data to be transmitted/received among terminals of the plurality of users during communication is not particularly limited. For example, data to be transmitted/received among the terminals 70 of the plurality of users may include at least one of sound data and haptic/tactile data. In the following description, an example will be described first where sound data is transmitted/received among the terminals 70 of the plurality of users.

The configuration example of the information processing system 1 according to the embodiment of the present disclosure has been described above.

### 1.2. Functional Configuration Example

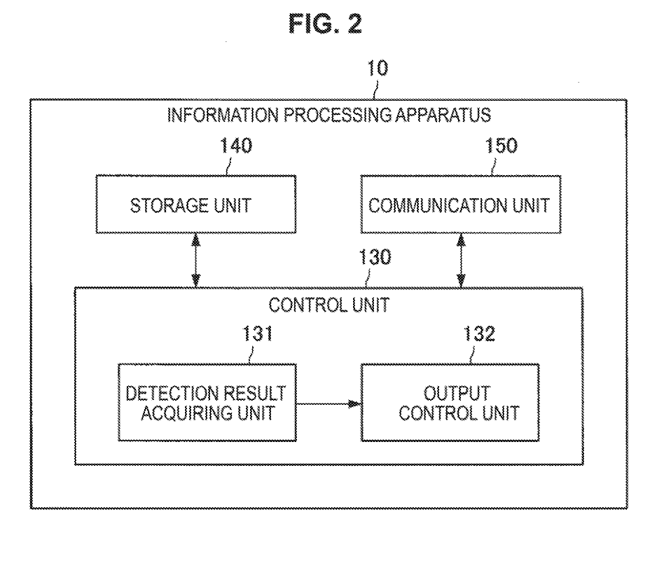

Subsequently, a functional configuration example of the information processing apparatus 10 according to the embodiment of the present disclosure will be described. FIG. 2 is a block diagram illustrating the functional configuration example of the information processing apparatus 10 according to the embodiment of the present disclosure. As illustrated in FIG. 2, the information processing apparatus 10 according to the embodiment of the present disclosure includes a control unit 130, a storage unit 140 and a communication unit 150.

The control unit 130 corresponds to, for example, a processor such as a central processing unit (CPU). The control unit 130 fulfills various functions of the control unit 130 by executing a program stored in the storage unit 140 or other storage media. The control unit 130 has various functional blocks such as a detection result acquiring unit 131 and an output control unit 132. Functions of these functional blocks will be described later. Note that, in the case where the control unit 130 is configured with a processor such as a CPU, the processor can be configured with an electronic circuit.

The storage unit 140 stores a program for causing the control unit 130 to operate using a storage medium such as a semiconductor memory and a hard disk. Further, for example, the storage unit 140 can also store various kinds of data to be used by the program. Note that, while the storage unit 140 is integrated with the information processing apparatus 10 in the example illustrated in FIG. 2, the storage unit 140 may be configured separately from the information processing apparatus 10.

The communication unit 150 can perform communication with other apparatuses. The communication unit 150 can perform communication via a network 60 in the case where the communication unit 150 performs communication with other apparatuses. A communication format by the communication unit 150 is not particularly limited, and communication by the communication unit 150 may be wireless communication or wire communication. Note that, while the communication unit 150 is integrated with the information processing apparatus 10 in the example illustrated in FIG. 2, the communication unit 150 may be configured separately from the information processing apparatus 10.

The functional configuration example of the information processing apparatus 10 according to the embodiment of the present disclosure has been described above.

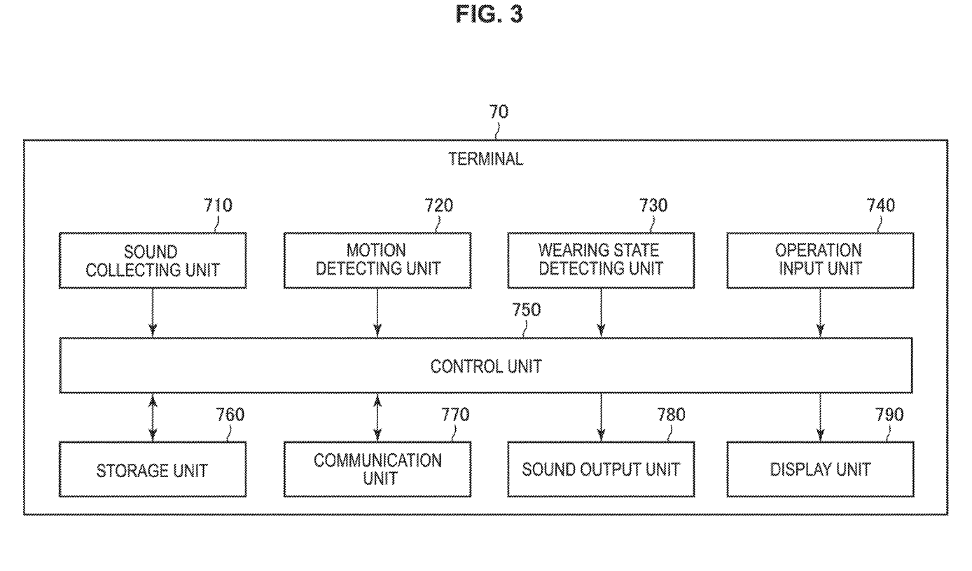

Subsequently, a functional configuration example of the terminal 70 according to an embodiment of the present disclosure will be described. FIG. 3 is a block diagram illustrating the functional configuration example of the terminal 70 according to the embodiment of the present disclosure. As illustrated in FIG. 3, the terminal 70 according to the embodiment of the present disclosure includes a sound collecting unit 10, a motion detecting unit 720, a wearing state detecting unit 730, an operation input unit 740, a control unit 750, a storage unit 760, a communication unit 770, a sound output unit 780 and a display unit 790.

The sound collecting unit 710 can function as a data detecting unit which detects data. Specifically, the sound collecting unit 710 collects sound data from the surroundings. For example, the sound collecting unit 710 can include a microphone. Sound data detected by the sound collecting unit 710 is output to the control unit 750. Note that, in the case where a headset and a body are separately provided, while, typically, the sound collecting unit 710 may be provided at the headset, a position where the sound collecting unit 710 is provided is not limited.

The motion detecting unit 720 detects motion of the terminal 70. For example, the motion detecting unit 720 can include an acceleration sensor which detects acceleration as sensing data, a gyro sensor which detects angular velocity as sensing data and an illuminance sensor which detects illuminance as sensing data. Motion detected by the motion detecting unit 720 is output to the control unit 750. Note that, in the case where the headset and the body are separately provided, while, typically, the motion detecting unit 720 may be provided at the headset, a position where the motion detecting unit 720 is provided is not limited.

The wearing state detecting unit 730 detects a wearing state of the terminal 70. For example, in the case where the terminal 70 is separated into a headset and a body, the wearing state detecting unit 730 can detect respective wearing states of the headset (the sound collecting unit 710, the motion detecting unit 720 and the sound output unit 780) and the body (the operation input unit 740, the control unit 750, the storage unit 760, the communication unit 770 and the display unit 790). The wearing state detected by the wearing state detecting unit 730 is output to the control unit 750.

The operation input unit 740 detects operation by the user and outputs the result to the control unit 730. For example, in the case where the input unit 720 is configured with a touch panel, the operation by the user can correspond to operation to the touch panel (such as, for example, tap operation and drag operation). However, the input unit 720 may be configured with a hardware (such as, for example, a button) other than the touch panel.

For example, a recognition result such as a user “grasping”, “looking at” and “touching” the terminal 70 (or the body of the terminal 70) may be detected as operation. Such a recognition result may be detected on the basis of a contact state of the hand of the user with respect to the terminal 70 obtained from information of a contact sensor (such as, for example, a touch sensor and a pressure sensor) which is located at the side of the terminal 70 and which is not illustrated. Further, such a recognition result may be detected by a predetermined motion pattern being extracted from output information of the motion detecting unit 720 (for example, the acceleration sensor and the gyro sensor).

Further, such a recognition result may be detected by the face being recognized from an image captured with a camera which is provided at the terminal 70 and which is not illustrated. Note that, in the case where the headset and the body are separately provided, while, typically, the operation input unit 740 may be provided at the headset, a position where the operation input unit 740 is provided is not limited.

The control unit 750 corresponds to, for example, a processor such as a CPU. The control unit 750 fulfils various functions of the control unit 750 by executing a program stored in the storage unit 760 or other storage media. Note that, in the case where the control unit 750 is configured with a processor such as a CPU, such a processor can be configured with an electronic circuit. Note that, in the case where the headset and the body are separately provided, while, typically, the control unit 750 may be provided at the body, a position where the control unit 750 is provided is not limited.

The storage unit 760 stores a program for causing the control unit 760 to operate using a storage medium such as a semiconductor memory and a hard disk. Further, for example, the storage unit 760 can also store various kinds of data to be used by the program. Note that, in the case where the headset and the body are separately provided, while, typically, the storage unit 760 may be provided at the body, a position where the storage unit 760 is provided is not limited.

The communication unit 770 can perform communication with other apparatuses. The communication unit 770 can perform communication via a network 60 in the case where, for example, the communication unit 750 performs communication with other apparatuses. A communication format by the communication unit 770 is not particularly limited, and communication by the communication unit 770 may be wireless communication or wire communication. Note that, in the case where the headset and the body are separately provided, while, typically, the communication unit 770 may be provided at the body, a position where the communication unit 770 is provided is not limited.

The sound output unit 780 outputs sound in accordance with control by the control unit 750. For example, the output unit 760 may include a speaker which outputs sound. For example, in the case where the sound output unit 780 includes a speaker which outputs sound, the speaker may be earphones or a headphone. Note that, in the case where the headset and the body are separately provided, while, typically, the sound output unit 780 may be provided at the headset, a position where the sound output unit 780 is provided is not limited.

The display unit 790 can include, for example, a display apparatus such as a liquid crystal display (LCD) and an organic electroluminescence (EL) display apparatus. Note that, in the case where the headset and the body are separately provided, while, typically, the display unit 790 may be provided at the body, a position where the display unit 790 is provided is not limited. Further, for example, the terminal 70 may include a light emitting diode (LED) which emits light separately from the display apparatus. Further, the terminal 70 can include a vibration device which is not illustrated.

The functional configuration example of the terminal 70 according to the embodiment of the present disclosure has been described above.

### 1.3. Details of Functions

Subsequently, details of functions of the information processing system 1 according to the embodiment of the present disclosure will be described. While, in the following description, a case will be mainly described where sound data is transmitted/received between a user U3 and a user UN, transmission/reception of the sound data is not limited to between the user U3 and the user UN. Further, there may be one user or a plurality of users at the reception side of sound data.

In the embodiment of the present disclosure, at the information processing apparatus 10, the output control unit 132 controls whether or not to perform delay processing of delaying output at a terminal 70-N of the user UN executed on the basis of sound data transmitted from a terminal 70-3 of the user U3, on the basis of a result of situation sensing with respect to the user UN. According to such a configuration, it is possible to realize either communication in which decrease of user-friendliness of the user UN is suppressed or communication in which a sense of oneness can be easily obtained in accordance with the situation of the user UN.

Here, in the case where the user UN is put into a state where the user UN can perceive an output result at the terminal 70-N of the user UN executed on the basis of the sound data, it is considered that the user UN can listen to the sound data in real time. On the other hand, in the case where the user UN is not put into a state where the user UN can perceive the output result at the terminal 70-N of the user UN executed on the basis of the sound data, it is considered that the user UN cannot listen to the sound data in real time. Therefore, the situation sensing may include sensing as to whether or not the user UN is put into a state where the user UN can perceive the output result at the terminal 70-N of the user UN executed on the basis of the sound data.

Further, whether or not the user UN is put into a state where the user UN can perceive the output result of the sound data may be detected using any method. For example, if the sound output unit 780 at the terminal 70-N of the user UN is activated, it is considered that the user UN is put into a state where the user UN can perceive the output result of the sound data. Therefore, whether or not the user UN is put into a state where the user UN can perceive the output result of the sound data may be detected in accordance with whether or not the sound output unit 780 at the terminal 70-N of the user UN is activated.

Further, if the sound output unit 780 at the terminal 70-N of the user UN is worn by the user UN, it is considered that the user UN is put into a state where the user UN can perceive the output result of the sound data. Therefore, whether or not the user UN is put into a state where the user UN can perceive the output result of the sound data may be detected in accordance with whether or not the sound output unit 780 at the terminal 70-N of the user UN is worn by the user UN.

Further, if the terminal 70-N of the user UN and the terminal 70-3 of the user U3 are connected to the same network 60, it is considered that the user UN is put into a state where the user UN can perceive the output result of the sound data. Therefore, whether or not the user UN is put into a state where the user UN can perceive the output result of the sound data may be detected in accordance with whether or not the terminal 70-N of the user UN and the terminal 70-3 of the user U3 are connected to the same network 60.

Further, in the case where a result of behavior recognition of the user UN indicates a predetermined result, it is considered that the user UN is put into a state where the user UN can perceive the output result of the sound data. Therefore, whether or not the user UN is put into a state where the user UN can perceive the output result of the sound data may be detected on the basis of a result of behavior recognition of the user U3. The result of behavior recognition of the user UN may be a location where the user UN exists or may be action of the user UN.

For example, if the location where the user UN exists is a predetermined location which is not appropriate for sound output (such as, for example, library and office), it may be detected that the user UN is not put into a state where the user UN can perceive the output result of the sound data. Meanwhile, if the location where the user UN exists is a predetermined location which is appropriate for sound output (such as, for example, station and shop), it may be detected that the user UN is put into a state where the user UN can perceive the output result of the sound data.

Further, if, for example, action of the user UN is predetermined action which is not appropriate for sound output (such as, for example, driving a car and working), it may be detected that the user UN is not put into a state where the user UN can perceive the output result of the sound data. Meanwhile, if the action of the user UN is predetermined action which is appropriate for sound output (such as, for example, walking, running, going up or down stairs and shopping), it may be detected that the user UN is put into a state where the user UN can perceive the output result of the sound data.

Further, in the case where the terminal 70-N of the user UN is grasped, touched or looked at by the user UN, it is considered that the user UN is put into a state where the user UN can perceive the output result of the sound data. Therefore, whether or not the user UN is put into a state where the user UN can perceive the output result of the sound data may be detected in accordance with whether or not the terminal 70-N of the user UN is grasped, touched or looked at by the user UN.

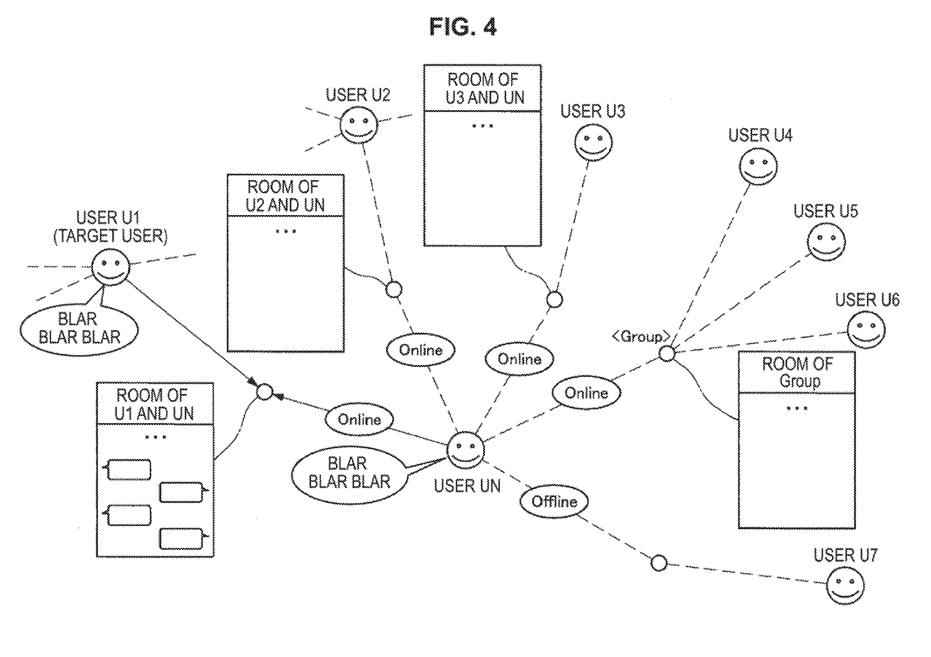

FIG. 4 is a diagram illustrating an example of human relationship based on the user UN. With reference to FIG. 4, while the terminal 70-N of the user UN is connected online to the terminal 70-3 of the user U3, the terminal 70-N of the user UN is not designated as a target user. Note that the target user can mean a user of a transmission destination of the sound data.

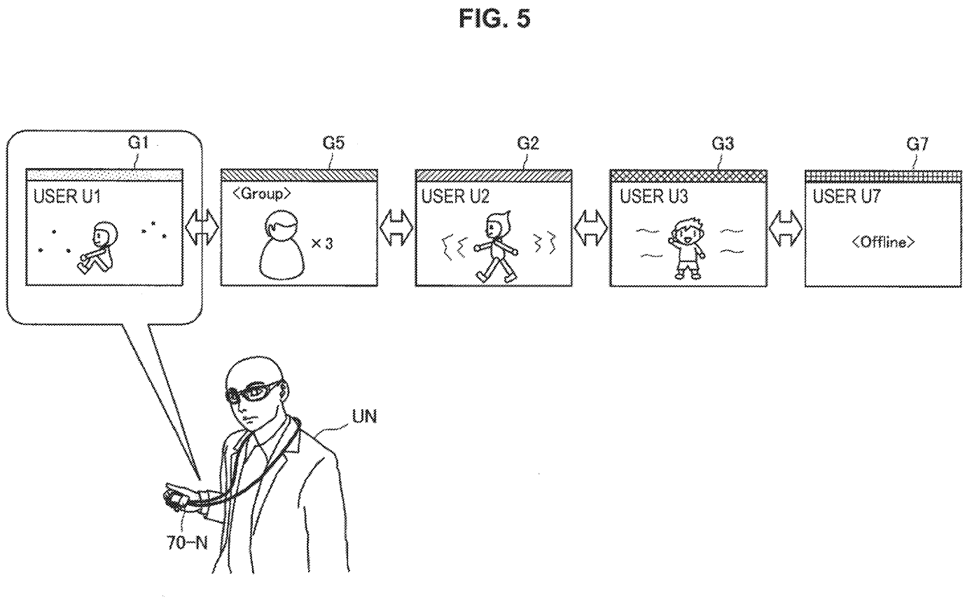

FIG. 5 is a diagram illustrating an example of a screen displayed by the terminal 70-N of the user UN (reception side user) before the sound data is transmitted from the terminal 70-3 of the user U3 to the terminal 70-N of the user UN. As illustrated in FIG. 5, a user U1 is designated as the target user. Therefore, at the terminal 70-N of the user UN, sound data collected by the sound collecting unit 710 of the terminal 70-1 of the target user (user U1) is output by the sound output unit 780, and an image (such as, for example, an avatar) corresponding to the target user (user U1) is displayed as a screen G1 by the display unit 790.

The target user can be selected through selection operation. For example, in the case where the detecting unit 710 includes a touch panel, the target user can be switched through flick operation (for example, flick operation in a horizontal direction or in a vertical direction) with respect to the touch panel. Further, the target user may be able to be switched with sound. FIG. 5 illustrates an example where, in the case where the target user is sequentially switched to the user U1, the group, the user U2, the user U3 and the user U7 in this order, a screen to be displayed by the display unit 790 of the terminal 70-N is sequentially switched to a screen G1, a screen G5, a screen G2, a screen G3 and a screen G7 in this order. In this event, each screen may be output in association with operation (such as blinking and change of emission color of the LED of the terminal 70-N) according to a degree of interest of the target user with respect to the user UN.

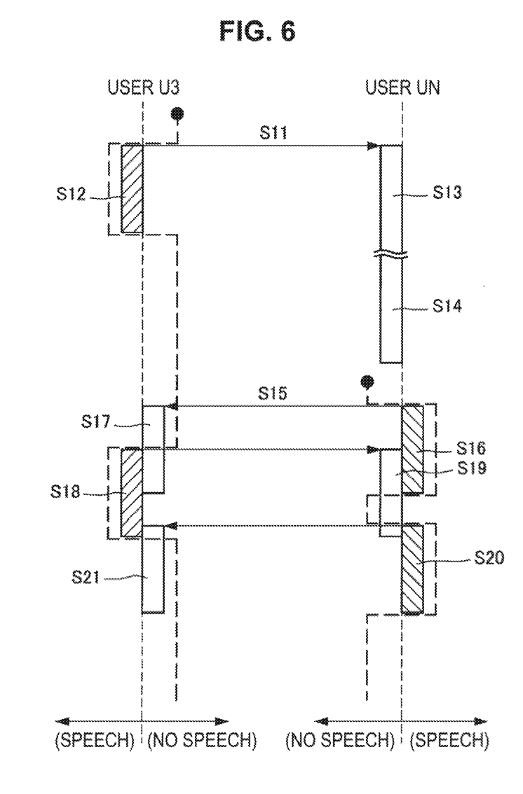

In such a state, a case will be assumed where sound data is transmitted/received between the terminal 70-3 of the user U3 and the terminal 70-N of the user UN. First, a first operation example of transmission/reception of sound data between the terminal 70-3 of the user U3 and the terminal 70-N of the user UN will be described with reference to FIG. 6. In the example illustrated in FIG. 6, a connection is always established between the terminal 70-3 of the user U3 and the terminal 70-N of the user UN. In the case where a connection is established between the terminals, it is possible to transmit/receive data between the terminals.

First, if the user U3 speaks while the sound collecting unit 710 is activated at the terminal 70-3 of the user U3, a speech segment is recognized from sound data collected by the sound collecting unit 710, and sound data of the speech segment is transmitted to the terminal 70-N of the user UN (S11). After speech by the user U3 continues for a while (S12), the speech is finished. In this event, the detection result acquiring unit 131 detects whether or not the user UN is put into a state where the user UN can perceive the output result of the sound data, and in the case where the user UN is not put into a state where the user UN can perceive the output result of the sound data, the output control unit 132 stores the sound data in a predetermined storage region (S13).

The storage region may be inside the storage unit 140 of the information processing apparatus 10 or may be inside the storage unit 760 of the terminal 70-3. Subsequently, in the case where the user UN is put into a state where the user UN can perceive the output result of the sound data, the output control unit 132 extracts the sound data from the storage region and outputs the sound data from the terminal 70-N of the user UN (S14). Subsequently, the user UN who perceives the sound data activates the sound collecting unit 710 and starts speech.

Subsequently, at the terminal 70-N of the user UN, a speech segment is recognized from the sound data collected by the sound collecting unit 710, and the sound data of the speech segment is transmitted to the terminal 70-3 of the user U3 (S15). After speech by the user UN continues for a while (S16), the speech is finished. If the user U3 is put into a state where the user U3 can perceive the output result of the sound data, the output control unit 132 outputs the sound data transmitted from the terminal 70-N of the user UN from the terminal 70-3 (S17). Subsequently, the user U3 who perceives the sound data starts speech.

Subsequently, S18 and S19 are executed in a similar manner to S16 and S17. Further, S20 and S21 are also executed in a similar manner to S16 and S17. As described above, in the case where the reception side user is not put into a state where the reception side user can perceive the sound data, output of the sound data at the reception side is delayed, and, in the case where the reception side user is put into a state where the reception side user can perceive the sound data, the sound data is output in real time. By this means, it is possible to realize either communication in which decrease of user-friendliness is suppressed or communication in which a sense of oneness can be easily obtained in accordance with a situation of the user.

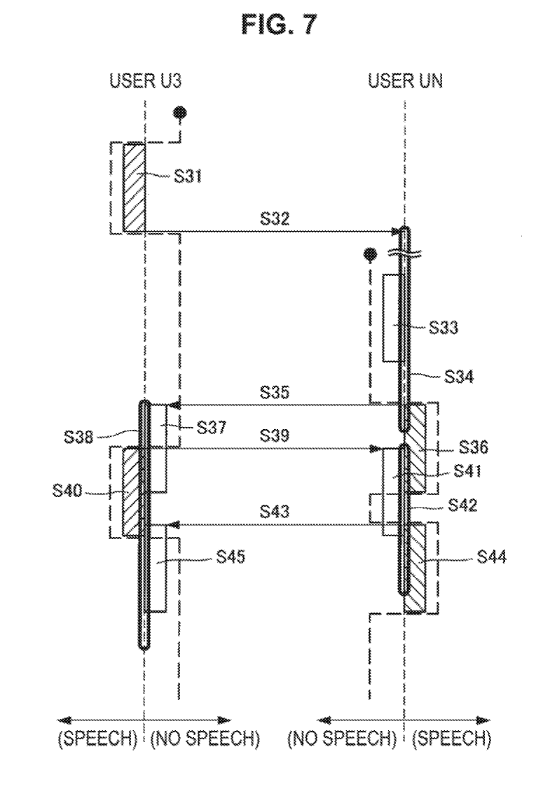

Subsequently, a second operation example of transmission/reception of the sound data between the terminal 70-3 of the user U3 and the terminal 70-N of the user UN will be described with reference to FIG. 7. In the example illustrated in FIG. 7, a connection is established between the terminal 70-3 of the user U3 and the terminal 70-N of the user UN as necessary.

First, if the user U3 speaks while the sound collecting unit 710 is activated at the terminal 70-3 of the user U3, the sound data collected by the sound collecting unit 710 is recorded (S31), and the sound data is transmitted to the terminal 70-N of the user UN on the basis of transmission operation (S32). In this event, the detection result acquiring unit 131 detects whether or not the user UN is put into a state where the user UN can perceive the output result of the sound data, and, in the case where the user UN is not put into a state where the user UN can perceive the output result of the sound data, the output control unit 132 stores the sound data in a predetermined storage region.

Subsequently, in the case where the user UN is put into a state where the user UN can perceive the output result of the sound data, the output control unit 132 extracts the sound data from the storage region and outputs the sound data from the terminal 70-N of the user UN (S33). The output control unit 132 activates the sound collecting unit 710 of the terminal 70-N of the user UN and automatically establishes a connection during a predetermined period after the sound data is stored in the storage region (S34). After speech by the user UN continues for a while (S36), the speech is finished. The output control unit 132 then recognizes a speech segment from the sound data acquired from the sound collecting unit 710 of the terminal 70-N of the user UN within a predetermined period, transmits sound data of the speech segment to the terminal 70-3 of the user U3 (S35) and outputs the sound data from the terminal 70-3 of the user U3 (S37).

Subsequently, S38 to S41 are executed in a similar manner to S34 to S37. Further, S42 to S45 are also executed in a similar manner to S34 to S37. As described above, in the case where the reception side user is not put into a state where the reception side user can perceive the sound data, output of the sound data at the reception side is delayed, and, in the case where the reception side user is put into a state where the reception side user can perceive the sound data, the sound data is output in real time. By this means, it is possible to realize either communication in which decrease of user-friendliness is suppressed or communication in which a sense of oneness can be easily obtained in accordance with a situation of the user.

Note that, in the second operation example, at the terminal 70-N, the sound collecting unit 710 is automatically activated, and a connection is automatically established. Therefore, in the case where the user UN has a face-to-face conversation with someone instead of conversation via the terminal 70-N, there is a possibility that face-to-face conversation may be transmitted to the terminal 70-3. Therefore, in the case where the user UN is having a face-to-face conversation, the output control unit 132 may shift the above-described predetermined period to a period after the face-to-face conversation is finished. Whether or not the user is having a face-to-face conversation may be judged on the basis of sound detected by a sound detecting unit which is not illustrated.

Further, a case is not limited to a face-to-face conversation, and there is a possibility that the sound data collected by the sound collecting unit 710 may be transmitted to the terminal 70-3 despite the intention of the user UN. Therefore, in order to allow the user UN to recognize that the period is within the predetermined period indicated in S34 and S42, the output control unit 132 preferably performs predetermined output from the terminal 70-N of the user UN within the above-described predetermined period. In a similar manner, in order to allow the user U3 to recognize that the period is within the predetermined period indicated in S38, the output control unit 132 preferably performs predetermined output from the terminal 70-3 of the user U3 within the above-described predetermined period. The predetermined output may be noise sound, or may be a predetermined sound pattern, or may be periodic notification sound. Further, predetermined output may be performed in a period other than the predetermined period in place of within the predetermined period.

Further, in the case where predetermined action (such as, for example, tap operation to the operation input unit 740) by the user UN is detected, the output control unit 132 may output an activation state of the sound collecting unit 710 of the terminal 70-N of the user UN (whether or not the sound collecting unit 710 of the terminal 70-N of the user UN is activated) from the terminal 70-N of the user UN.

Alternatively, in the case where predetermined conditions are satisfied after the sound collecting unit 710 of the terminal 70-N of the user UN is activated, the output control unit 132 may stop the sound collecting unit 710 of the terminal 70-N of the user UN. The predetermined conditions may be conditions that a predetermined period has elapsed since the sound collecting unit 710 of the terminal 70-N of the user UN is activated, or may be conditions that speech segment has not been recognized for a predetermined period since the sound collecting unit 710 of the terminal 70-N of the user UN is activated.

Alternatively, the output control unit 132 may use the sound data collected in the case where predetermined gesture by the user UN is detected as a transmission target from the terminal 70-N of the user UN to the terminal 70-3 of the user U3. The predetermined gesture may be gesture of tilting the head downward or may be action of shaking the head to right and left.

Alternatively, the output control unit 132 may determine whether or not the sound data is used as a transmission target from the terminal 70-N of the user UN to the terminal 70-3 of the user U3 on the basis of an analysis result of the sound data collected by the sound collecting unit 710 of the terminal 70-N of the user UN. For example, the output control unit 132 may not use the sound data as a transmission target from the terminal 70-N of the user UN to the terminal 70-3 of the user U3 in the case where the analysis result of the sound data indicates that the conversation is face-to-face conversation.

The second operation example has been described above. Description regarding functions common between the first operation example and the second operation example will be continued. Even in the case where the user UN is put into a state where the user UN can perceive the output result of the sound data, the output control unit 132 may store the sound data transmitted from the terminal 70-3 of the user U3 in a storage region. By this means, the user UN can listen to the sound data stored in the storage region later as well as can listen to the sound data in real time. In this event, as an amount of the sound data stored in the storage region increases, the user UN takes more time to listen to the sound data later.

Therefore, the output control unit 132 preferably makes output speed when the sound data extracted from the storage region is output from the terminal 70-N of the user UN higher than reference speed. Alternatively, the output control unit 132 may omit output of a predetermined segment included in the sound data extracted from the storage region or may make output speed of a predetermined segment higher than reference speed.

Alternatively, the output control unit 132 outputs an output portion specified on the basis of the analysis result of the sound data extracted from the storage region from the terminal 70-N of the user UN. For example, the output control unit 132 may output an important portion or speech content of a specific user specified through analysis of conversation content of the sound data, from the terminal 70-N of the user UN.

Further, also in the case where the sound data from the user U3 is output by the terminal 70-N of the user UN, and the user UN can listen to the sound data, there can be a case where the user UN cannot return sound data to the user U3 in the case where the user UN is located in a quiet location, or the like. Therefore, if predetermined hold operation (such as, for example, action of shaking the terminal 70-N) by the user UN is detected, the output control unit 132 may output a predetermined hold notification (such as, for example, predetermined vibration and a predetermined sound pattern) from the terminal 70-3 of the user U3.

Further, there is a possibility that the user UN may be astonished by sudden output of sound data from the terminal 70-N. Therefore, when the output control unit 132 outputs sound data from the terminal 70-N of the user UN, the output control unit 132 preferably performs predetermined output (such as, for example, noise sound and surrounding sound of the terminal 70-3) from the terminal 70-N of the user UN a predetermined period before output of the sound data is started until output of the sound data is started.

Alternatively, when the output control unit 132 outputs sound data from the terminal 70-N of the user UN, the output control unit 132 preferably changes a portion of the sound data until a predetermined period has elapsed since output of the sound data is started and outputs the sound data from the terminal 70-N of the user UN. Change may be made in any way. For example, change may be made such that sound is fade in, or as if a sound source gradually approached.

Further, there is also a case where the user U3 desires to delete transmitted sound data. Therefore, the output control unit 132 preferably deletes sound data stored in the storage region in the case where predetermined deletion conditions are satisfied. For example, only the sound data selected by the user U3 may be deleted, or sound data selected by the user U3 and sound data stored after the sound data may be deleted. Alternatively, the output control unit 132 may delete sound data of the last speech segment or may delete the last sound data of several seconds. Alternatively, the output control unit 132 may delete the sound data in the case where a period while data is not output from the terminal 70-N of the user UN exceeds a predetermined period.

Further, there is a case where it is difficult to understand from whom the output sound data is transmitted only by listening to the sound data. Therefore, the output control unit 132 preferably outputs the sound data from the terminal 70-N of the user UN using an output scheme in accordance with the user U3. For example, the output control unit 132 may output sound data so that the user UN can listen to the sound data from a direction corresponding to the user U3. Alternatively, the output control unit 132 may output music corresponding to the user U3 at the same time as output of the sound data.

Alternatively, the output control unit 132 may output notification sound corresponding to the user U3 at a timing of at least one of during output of the sound data, immediately before and immediately after the sound data is output. Alternatively, the output control unit 132 may output vibration corresponding to the user U3 at a timing of at least one of during output of the sound data, immediately before and immediately after the sound data is output.

Further, there is also a case where the user UN cannot speak loudly such as a case where there is people around the user UN and a case where the user UN is located in a quiet location. Therefore, the output control unit 132 preferably adjusts a volume of sound data to be transmitted to the terminal 70-3 of the user U3 on the basis of an acoustic pattern of voice of the user UN registered in advance or measured and sound information collected by the sound collecting unit 710 of the terminal 70-N. Specifically, the output control unit 132 preferably adjusts a volume level of the sound information to be constant on the basis of the acoustic pattern.

Further, a degree of importance of the sound data may be taken into account when whether or not to delay output of the sound data is controlled. That is, the output control unit 132 may control whether or not to delay output at the terminal 70-N of the user UN in accordance with the degree of importance of the sound data. The degree of importance of the sound data may be attached to the sound data or may be obtained through analysis of the sound data.

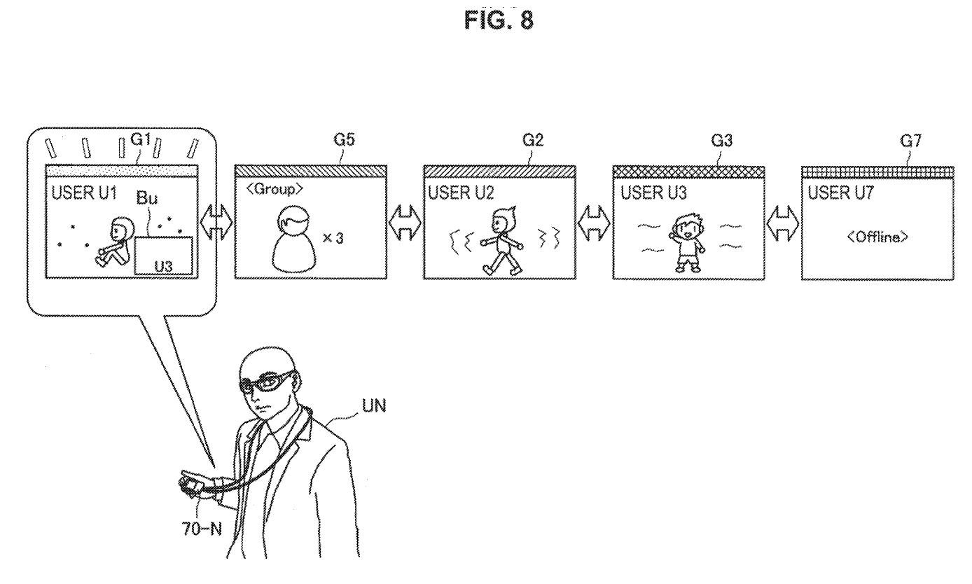

FIG. 8 is a diagram illustrating an example of a screen displayed by the terminal 70-N of the user UN in the case where sound data is transmitted from the user U3. As illustrated in FIG. 8, in the case where the user U1 is selected as a target user, at the terminal 70-N of the user UN, the display unit 790 displays a screen G1. Here, the terminal 70-N executes predetermined operation when sound data is transmitted from the user U3. While FIG. 8 illustrates an example where an LED of the terminal 70-N is blinked as the predetermined operation, the predetermined operation is not limited to this example as described above. For example, the predetermined operation may be operation of changing color of light emitted by the LED of the terminal 70-N.

Note that a vibration pattern or a vibrating portion (or an LED blinking pattern or blinking portion) of the terminal 70-N is preferably different between a case where sound data is transmitted from the target user and a case where sound data is transmitted from a user other than the target user. By this means, the user UN can easily understand whether sound data is transmitted from the target user or sound data is transmitted from a user other than the target user.

Further, it is preferably possible to rearrange one or more users (user U1, group, user U2, user U3 and user U7) which can be selected as a notification destination user. For example, the output control unit 132 may manually by the user UN or automatically arrange one or more users (user U1, group, user U2, user U3 and user U7) which can be selected as the notification destination user in a predetermined order. The predetermined order may be a reverse chronological order of transmission of sound data to the user UN or may be a reverse chronological order of transmission of sound data from the user UN or a descending order of frequency of transmission/reception of sound data to/from the user UN.

Here, how to deal with the target user at the terminal 70-3 of the user U3 will be described. For example, the output control unit 132 only has to output the sound data transmitted from the terminal 70-3 of the user U3 from the terminal 70-N of the user UN in the case where the user UN is designated as the target user, and in the case where the user UN is put into a state where the user UN can perceive the output result of the sound data.

Further, the output control unit 132 may output the sound data transmitted from the terminal 70-3 of the user U3 from the terminal 70-N of the user UN in the case where the user UN is not designated as the target user and in the case where the user UN is put into a state where the user UN can perceive the output result of the sound data. Alternatively, in similar cases, the output control unit 132 may store the sound data transmitted from the terminal 70-3 of the user U3 in the storage region and output an indication that the sound data is transmitted, from the terminal 70-N of the user UN (may deal with the state as a state where the user UN cannot perceive the output result of the sound data).

Here, in the case where sound data transmitted/received in real time in the past is stored, the sound data can be also listened to later. In this event, in a similar manner to a case where the sound data is delayed and output, as an amount of sound data increases, the user UN takes more time to listen to the sound data later.

Therefore, if a predetermined history confirmation trigger (such as, for example, depression of a history confirmation button) is detected, the output control unit 132 preferably outputs predetermined history data recognized from the transmission/reception data between the terminal 70-3 of the user U3 and the terminal 70-N of the user UN stored in the storage region from the terminal 70-N of the user UN. For example, the history data may include text data recognized from the transmission/reception data.

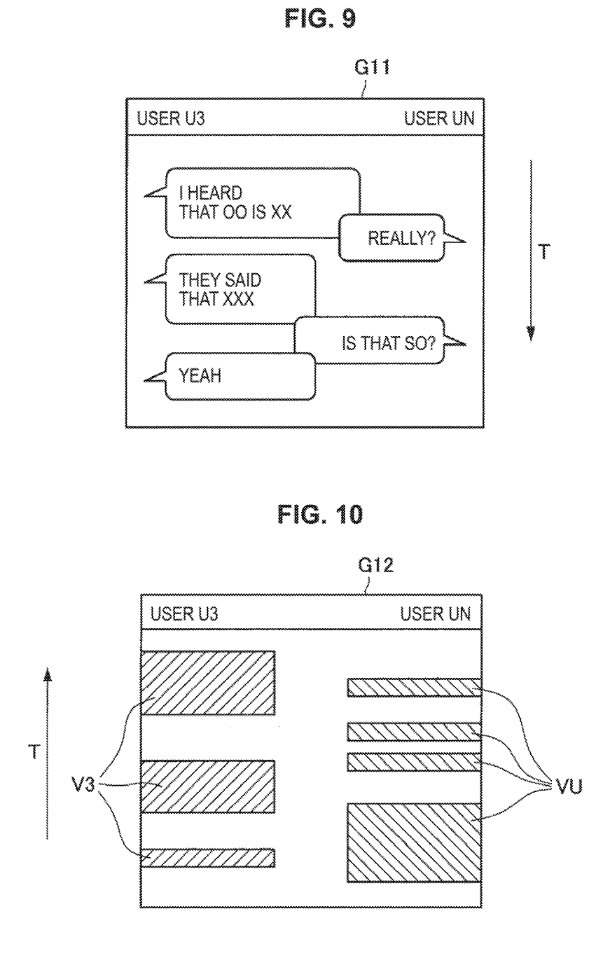

FIG. 9 is a diagram illustrating a display example of the text data recognized from the transmission/reception data. As in a screen G11, the output control unit 132 may display the text data recognized from the transmission/reception data as the history data. In this event, as illustrated in FIG. 9, the text data may be displayed for each speech segment of each of a plurality of users (the user U3 and the user UN). Further, as illustrated in FIG. 9, the text data may be displayed at a position on a time axis T corresponding to time at which speech is made.

Alternatively, the history data may include a length of speech of a user for each speech segment recognized from the transmission/reception data. FIG. 10 is a diagram illustrating a display example of the length of the speech of the user for each speech segment recognized from the transmission/reception data. As in a screen G12, the output control unit 132 may display the length of the speech of the user recognized from the transmission/reception data as the history data. In this event, as illustrated in FIG. 10, the length of the speech may be displayed (V3, VU) for each speech segment of each of the plurality of users (the user U3 and the user UN). Further, as illustrated in FIG. 10, the length of the speech may be displayed at a position on the time axis T corresponding to time at which speech is made.

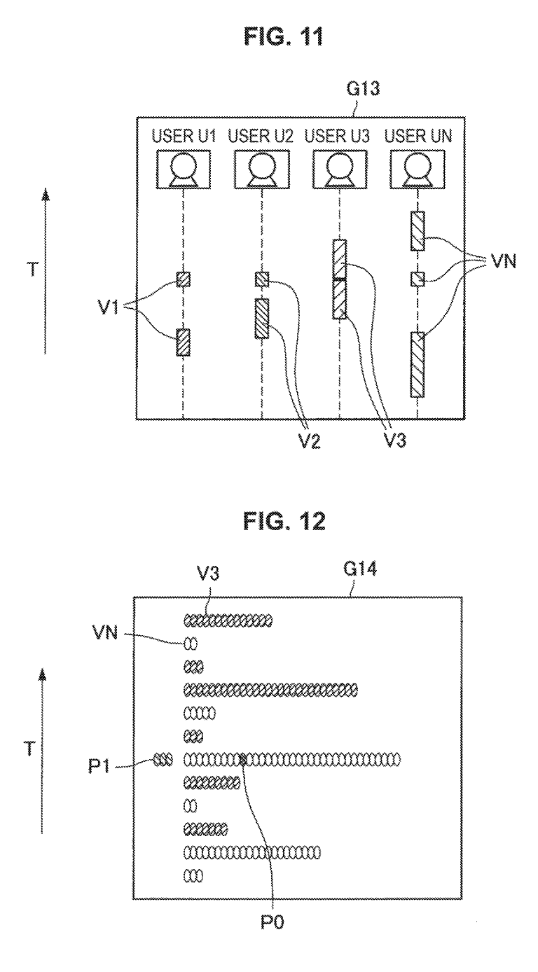

FIG. 11 is a diagram illustrating a display example of a length of speech of each of a plurality of users (users U1, U2, U3, UN) belonging to a group. As in a screen G13, as illustrated in FIG. 11, the length of the speech may be displayed (V1, V2, V3, VU) for each speech segment of each of the plurality of users (users U1, U2, U3, UN) belonging to the group. Further, as illustrated in FIG. 11, the length of the speech may be displayed at a positon on the time axis T corresponding to time at which speech is made.

FIG. 12 is a diagram illustrating another display example of the length of the speech of the user for each speech segment recognized from the transmission/reception data. As in a screen G14, the output control unit 132 may display the length of the speech of the user recognized from the transmission/reception data as the history data. In this event, as illustrated in FIG. 12, the length of the speech may be displayed (V3, VU) for each speech segment of each of the plurality of users (the user U3 and the user UN). Further, as illustrated in FIG. 12, the data may be indicated along time T in consecutive order of speech, and the length of the speech may be indicated with a bar.

Further, as illustrated in FIG. 12, the output control unit 132 may output a current output position of the sound data from the terminal 70-N as a position P0. Further, the output control unit 132 can move a cursor P1 through operation by the user UN (for example, operation of depressing up, down, right and left keys). For example, when selection operation (such as, for example, tap operation and operation of depressing a determination key) is performed by the user UN, the output control unit 132 can output a speech segment corresponding to a position of a cursor P0 from the terminal 70-N.

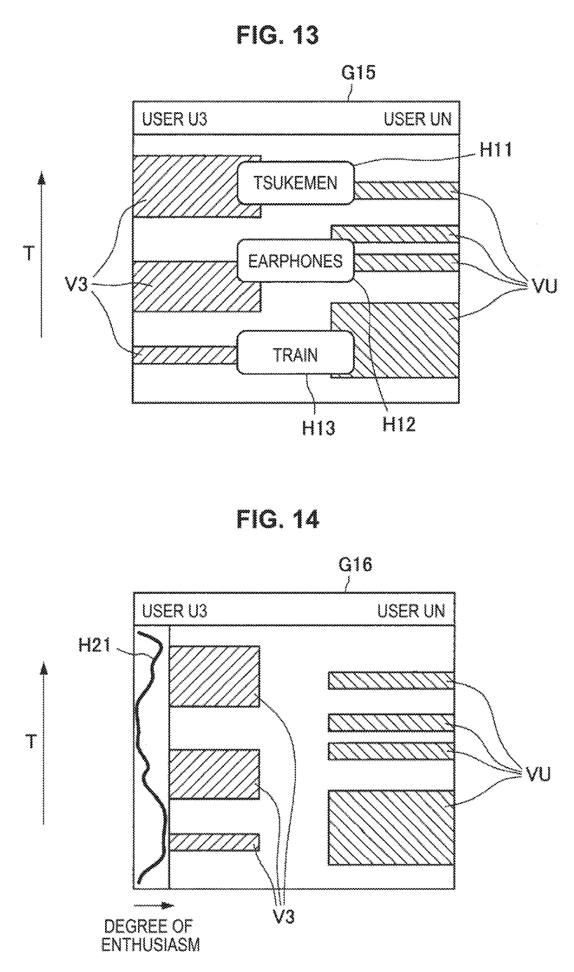

Still further, the history data may include a topic or a keyword recognized from the transmission/reception data. FIG. 13 is a diagram illustrating a display example of the topic or the keyword recognized from the transmission/reception data. As in a screen G15, the output control unit 132 may display the topic or the keyword recognized from the transmission/reception data as the history data. In this event, as illustrated in FIG. 13, the topic or the keyword may be displayed at a position on the time axis T corresponding to time at which speech is made.

Further, the history data may include a degree of enthusiasm of conversation recognized from the transmission/reception data. FIG. 14 is a diagram illustrating a display example of the degree of enthusiasm of conversation recognized from the transmission/reception data. As in a screen G16, the output control unit 132 may display a degree of enthusiasm H21 of the conversation recognized from the transmission/reception data as the history data. In this event, as illustrated in FIG. 14, the degree of enthusiasm H21 of the conversation may be displayed at a position on the time axis T corresponding to time at which speech is made in a graph.

The degree of enthusiasm may be calculated using any method. For example, the degree of enthusiasm may be calculated through acoustic analysis of the sound data (for example, a higher degree of enthusiasm is calculated for higher pitch sound). Further, the degree of enthusiasm may be calculated through semantic analysis of the conversation. Alternatively, the degree of enthusiasm may be calculated through analysis of tempo of the conversation (such as, for example, response speed and frequency). Alternatively, the degree of enthusiasm may be calculated through analysis of vital information (such as, for example, a degree of perspiration) of the user (for example, a higher degree of enthusiasm is calculated for a higher degree of perspiration).

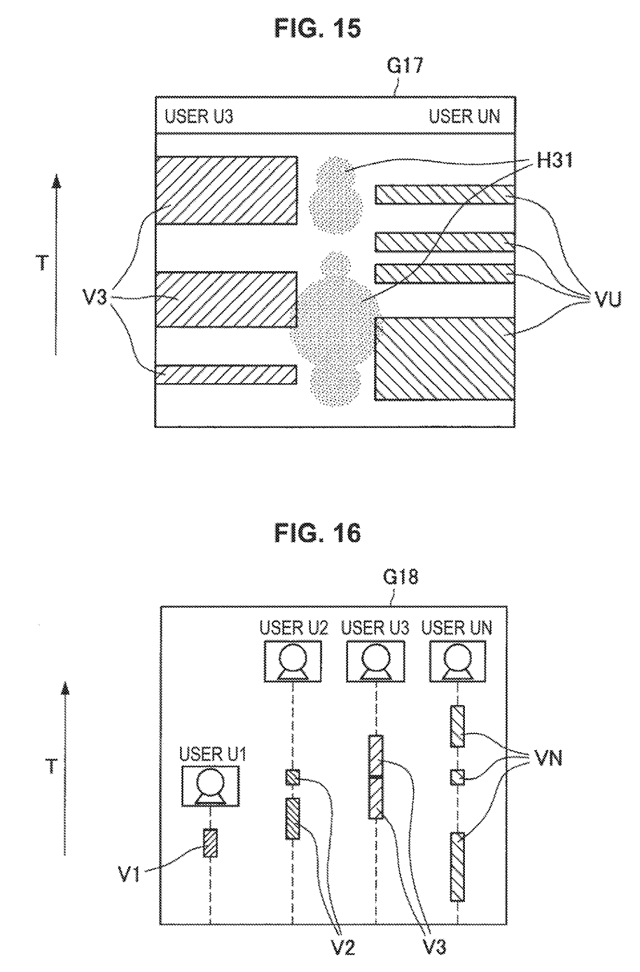

There can exist a variety of display forms of the degree of enthusiasm of the conversation. FIG. 15 is a diagram illustrating another display example of the degree of enthusiasm of the conversation recognized from the transmission/reception data. As in a screen G17, the output control unit 132 may display a degree of enthusiasm H31 of the conversation recognized from the transmission/reception data as the history data. In this event, as illustrated in FIG. 15, in the case where there is enthusiasm exceeding a threshold, the degree of enthusiasm H31 of the conversation may be displayed with predetermined color at a position on the time axis T corresponding to the time.

Further, the degree of enthusiasm may be displayed with change of a color phase. For example, the output control unit 132 may display a predetermined object which changes from first color (such as, for example, blue) to second color (such as, for example, red) as the degree of enthusiasm increases at a position on the time axis T corresponding to the time.

Further, it is preferable for the user U3 to understand whether or not the user UN listens to content of speech of the user U3 in real time. Therefore, the output control unit 132 preferably performs control so that information indicating whether or not the user UN is put into a state where the user UN can perceive the output result is output from the terminal 70-3 of the user U3. For example, information indicating that the user UN is not put into a state where the user UN can perceive the output result may be output as predetermined notification sound, predetermined vibration, speech itself of the user U3 or other notification information.

The information indicating that the user UN is not put into a state where the user UN can perceive the output result may be output when the user starts speech, or may be output when the user UN is put into a state where the user UN cannot perceive the output result, or may be always output or may be output when the user U3 performs predetermined action (such as, for example, action of shaking the terminal and action of depressing a button) with respect to the terminal 70-3, or may be output when the user U3 switches the target user.

Further, it is preferable for the user U3 to understand whether or not the user UN actually listens to the sound data while the sound data is output from the terminal 70-N. Therefore, the output control unit 132 preferably performs control so that measurement information regarding the body of the user UN or an analysis result of the measurement information is output from the terminal 70-3 of the user U3.

Specifically, the analysis result of the measurement information may be information indicating whether or not the user UN listens to the sound data, obtained by analyzing the measurement information of brain waves (bursting state of a speech area) of the user UN. Alternatively, the analysis result of the measurement information may be information indicating whether or not the user UN listens to the sound data, obtained by analyzing motion of the body of the user UN. Alternatively, the analysis result of the measurement information may be change of feeling obtained from vital information of the user UN.

In the case where sound data is transmitted/received among a plurality of users belonging to a group, there can be a case where it is desired to understand a user who listens to the sound data. FIG. 16 is a diagram illustrating an example where, in the case where sound data is transmitted/received among a plurality of users belonging to a group, whether or not each user listens to sound data is displayed. As illustrated in FIG. 16, to which position the sound data is listened to may be displayed with a position on the time axis T of an icon of each user. In a screen G18, while the users U2, U3 and UN currently listen to the sound, the user U1 stops listening to the sound a short time ago.

Further, in the case where the sound data is transmitted/received among the plurality of users belonging to the group, and, in the case where not all of the plurality of users belonging to the group are put into a state where the users can perceive the output result of the sound data, the output control unit 132 preferably performs control to output information indicating that the users are not put into a state where the users can perceive the output result. Further, the output control unit 132 may output information indicating that the users are not put into a state where the users can perceive the output result with strength in accordance with a ratio of users who are not put into a state where the users can perceive the output result of the sound data.

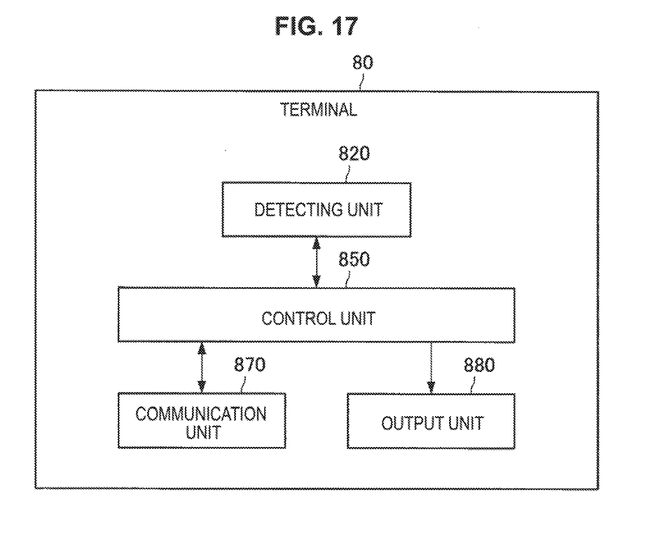

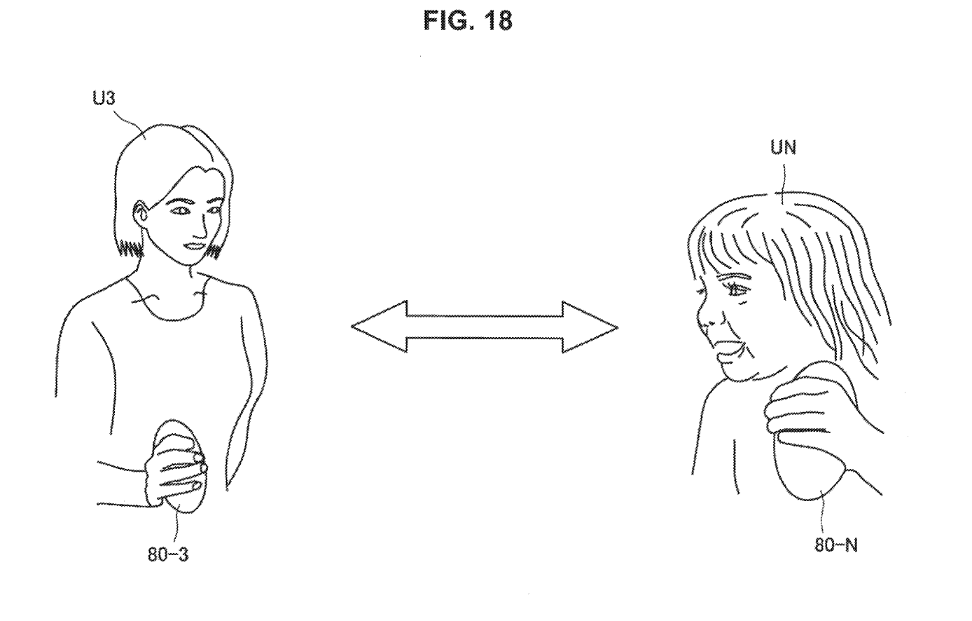

An example where the sound data is transmitted/received among terminals of the plurality of users has been described above. However, as described above, haptic/tactile data may be transmitted/received among the terminals of the plurality of users. FIG. 17 is a diagram illustrating a functional configuration example of the terminal 80 in the case where haptic/tactile data is transmitted/received among the terminals 80 of the plurality of users. As illustrated in FIG. 17, the terminal 80 includes a detecting unit 820, a control unit 850, a communication unit 870 and an output unit 880.

The detecting unit 820 has a function of detecting detection data (such as, for example, touch, deformation, shaking and tracing) provided by the user. The control unit 850, for example, corresponds to a processor such as a CPU. The control unit 850 generates haptic/tactile data (such as, for example, touch, deformation, shaking and tracing) on the basis of the detection data. The control unit 850 fulfils various functions by executing a program. The communication unit 870 can perform communication with other apparatuses. The output unit 880 outputs the haptic/tactile data.

For example, a timing at which transmission of the haptic/tactile data is started may be when the user touches the terminal 80. Further, the haptic/tactile data may be continuously transmitted while the user touches the terminal 80, and transmission of the haptic/tactile data may be finished when touch of the user with respect to the terminal 80 is released. Alternatively, a timing at which transmission of the haptic/tactile data is started may be when the user starts touching the terminal 80 in a state where a predetermined button is depressed. In this event, the haptic/tactile data may be continuously transmitted while the user touches the terminal 80 in a state where the predetermined button is depressed, and transmission of the haptic/tactile data may be finished when touch of the user with respect to the terminal 80 is released. Further, in the case where the terminal 80 is grasped or touched by the user, it is considered that the user is put into a state where the user can perceive the output result of the haptic/tactile data. Therefore, whether or not the user is put into a state where the user can perceive the output result of the haptic/tactile data may be detected in accordance with whether or not the terminal 80 is grasped or touched by the user.

FIG. 18 is a diagram illustrating an aspect where the haptic/tactile data is transmitted/received to/from each other. As illustrated in FIG. 18, the haptic/tactile data is transmitted/received between a terminal 80-3 of the user U3 and a terminal 80-N of the user UN. Also in this case, in a similar manner to a case where the sound data is transmitted/received, it is possible to suppress decrease of user-friendliness and provide tactile and a sense of force so that a sense of oneness can be easily obtained by controlling processing of delaying haptic/tactile data.

The details of the functions of the information processing system 1 according to the embodiment of the present disclosure have been described above.

### 1.4. Hardware Configuration Example

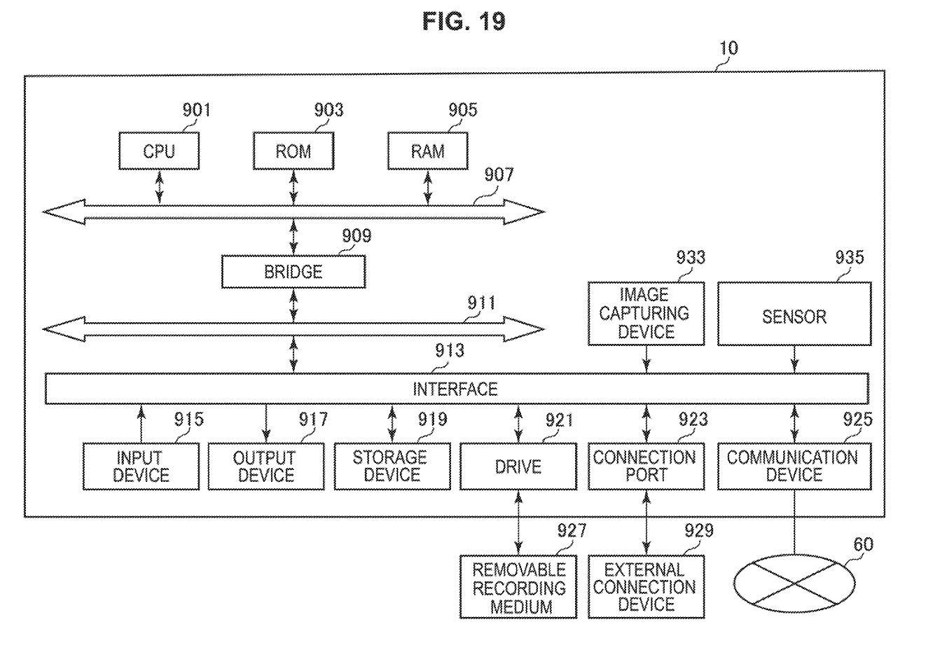

The hardware configuration of the information processing apparatus 10 according to the embodiment of the present disclosure is now described with reference to FIG. 19. FIG. 19 is a block diagram illustrating a hardware configuration example of the information processing apparatus 10 according to the embodiment of the present disclosure.

As illustrated in FIG. 19, the information processing apparatus 10 includes a central processing unit (CPU) 901, a read only memory (ROM) 903, and a random access memory (RAM) 905. In addition, the information processing apparatus 10 may include a host bus 907, a bridge 909, an external bus 911, an interface 913, an input device 915, an output device 917, a storage device 919, a drive 921, a connection port 923, and a communication device 925. The information processing apparatus 10 may further include an image capturing device 933 and a sensor 935 as necessary. In conjunction with, or in place of, the CPU 901, the information processing apparatus 10 may have a processing circuit called a digital signal processor (DSP) or application specific integrated circuit (ASIC).

The CPU 901 functions as an arithmetic processing unit and a control device, and controls the overall operation in the information processing apparatus 10 or a part thereof in accordance with various programs recorded in the ROM 903, the RAM 905, the storage device 919, or the removable recording medium 927. The ROM 903 stores, for example, programs and operation parameters used by the CPU 901. The RAM 905 temporarily stores, for example, programs to be used in the execution by the CPU 901 and parameters that change as appropriate in executing the programs. The CPU 901, the ROM 903, and the RAM 905 are connected with each other via a host bus 907 that is composed of an internal bus such as a CPU bus. Furthermore, the host bus 907 is connected to an external bus 911 such as peripheral component interconnect (PCI)/interface bus via a bridge 909.

The input device 915 is, for example, a device operated by a user, such as a mouse, a keyboard, a touch panel, a button, a switch, and a lever. The input device 915 may include a microphone for detecting user's voice. The input device 915 may be, for example, a remote control device using infrared rays or other radio waves, or may be an external connection device 929 such as a cellular phone conforming to the operation of the information processing apparatus 10. The input device 915 includes an input control circuit that generates an input signal on the basis of the information input by the user and outputs it to the CPU 901. The user inputs various data to the information processing apparatus 10 and instructs the information processing system 10 to perform a processing operation by operating the input device 915. In addition, the image capturing device 933, which will be described later, can also function as an input device by capturing the movement of the user's hand or finger, and the like. In this case, the pointing position may be determined depending on the motion of the hand or the orientation of the finger.

The output device 917 is composed of a device capable of notifying visually or audibly the user of the acquired information. The output device 917 may be a display device such as a liquid crystal display (LCD), a plasma display panel (PDP), an organic electro-luminescence (EL) display, and a projector, a hologram display device, an audio output device such as a speaker and a headphone, as well as printer devices or the like. The output device 917 outputs the result obtained by the processing of the information processing apparatus 10 as a video such as a text or an image, or outputs it as audio such as a voice or sound. In addition, the output device 917 may include, for example, a light for lighting up the surroundings.

The storage device 919 is a data storage device configured as an example of a storage portion of the information processing apparatus 10. The storage device 919 is composed of, for example, a magnetic storage device such as hard disk drives (HDDs), a semiconductor storage device, an optical storage device, and a magneto-optical storage device. The storage device 919 stores programs executed by the CPU 901, various data, various types of data obtained from the outside, and the like.

The drive 921 is a reader-writer for a removable recording medium 927 such as a magnetic disk, an optical disk, a magneto-optical disk, and a semiconductor memory, and is incorporated in the information processing apparatus 10 or externally attached thereto. The drive 921 reads the information recorded in the attached removable recording medium 927 and outputs it to the RAM 905. In addition, the drive 921 writes in the attached removable recording medium 927.

The connection port 923 is a port for directly connecting the device to the information processing apparatus 10. The connection port 923 may be, for example, a universal serial bus (USB) port, an IEEE 1394 port, or a small computer system interface (SCSI) port. In addition, the connection port 923 may be, for example, an RS-232C port, an optical audio terminal, or high-definition multimedia interface (HDMI, registered trademark) port. The external connection device 929 is connected to the connection port 923, and thus various kinds of data can be exchanged between the information processing apparatus 10 and the external connection device 929.

The communication device 925 is, for example, a communication interface composed of a communication device or the like, which is used to be connected to the communication network 60. The communication device 925 may be, for example, a communication card for wired or wireless local area network (LAN), Bluetooth (registered trademark), or wireless USB (WUSB). In addition, the communication device 925 may be, for example, a router for optical communication, a router for asymmetric digital subscriber line (ADSL), or a modem for various communications. The communication device 925 transmits and receives signals or the like using a predetermined protocol such as TCP/IP, for example, with the Internet or other communication devices. In addition, the communication network 60 connected to the communication device 925 is a network connected by wire or wireless, and is, for example, the Internet, home LAN, infrared communication, radio wave communication, satellite communication, or the like.

The image capturing device 933 captures a real space and generates a captured image, by using an image sensor such as charge-coupled device (CCD) or complementary-metal-oxide semiconductor (CMOS) and various members such as a lens for controlling imaging of a subject image on the image sensor. The image capturing device 933 may capture a still image or a moving image.

The sensor 935 is, for example, various sensors such as an accelerometer, a gyro sensor, a geomagnetic sensor, a photosensor, and a sound sensor. The sensor 935 acquires information on the state of the information processing apparatus 10 itself, such as the attitude of the casing of the information processing apparatus 10, and information on the surrounding environment of the information processing apparatus 10 such as brightness or noise around the information processing apparatus 10. The sensor 935 may also include a GPS sensor, which receives global positioning system (GPS) signals and measures the latitude, longitude, and altitude of the device.

The above description is given as to the example of the hardware configuration of the information processing apparatus 10. Each of the components described above may be configured using a general-purpose member, or may be configured with hardware dedicated to the function of each component. Such a configuration can be changed appropriately depending on the technical level at the time of implementation.

### 2. CONCLUSION

As described above, according to the embodiment of the present disclosure, the information processing apparatus 10 is provided which includes an output control unit 132 configured to control whether or not to perform delay processing of delaying output of first data transmitted from a terminal of a first user at a terminal of a second user on the basis of a result of situation sensing with respect to the second user. According to this configuration, it is possible to realize either communication in which decrease of user-friendliness is suppressed or communication in which a sense of oneness can be easily obtained in accordance with a situation of the user.

The preferred embodiment of the present disclosure has been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

In the above description, an example has been described where, in the case where the terminal 70 is separated into a headset and a body, operation is input by the operation input unit 740 provided at the body and a screen is displayed by the display unit 790 provided at the body. However, which device inputs operation and displays a screen is not limited. For example, operation may be input and a screen may be displayed by another device (such as, for example, a smartphone) wirelessly connected to the terminal 70. In this case, it is possible to display a screen with a larger information amount. Further, in this event, in addition to the headset and the body, another device may exist, or the headset and another device may exist while the body does not exist.

Furthermore, it is possible to create a program for causing the hardware such as CPU, ROM and RAM incorporated in the computer to execute functions equivalent to those of the information processing apparatus 10 as described above. In addition, a computer-readable recording medium on which the program is recorded can also be provided.

Note that positions of respective components are not particularly limited if the above-described operation of the information processing system 1 is realized. For example, while a case has been described in the above-described example where the information processing apparatus 10 functions as a server, each of the terminals 70-1 to 70-N may have part or all of the functions of the information processing apparatus 10. For example, each of the terminals 70-1 to 70-N may have the detection result acquiring unit 131 and the output control unit 132. Further, part or all of the information processing apparatus 10, the recognizing apparatus 21 and the analyzing apparatus 22 may be incorporated into the same apparatus.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

An information processing apparatus including:

a control unit configured to control whether or not to perform delay processing of delaying output at a terminal of a second user executed on the basis of first data transmitted from a terminal of a first user, on the basis of a result of situation sensing with respect to the second user.

(2)

The information processing apparatus according to (1),

in which the situation sensing includes sensing of whether or not the second user is in a state where the second user can perceive a result of output of the first data at the terminal of the second user.

(3)

The information processing apparatus according to (2),

in which whether or not the second user is in a state where the second user can perceive the result of output is detected in accordance with whether or not an output unit configured to output the first data in the terminal of the second user is activated.

(4)

The information processing apparatus according to (2),

in which whether or not the second user is in a state where the second user can perceive the result of output is detected in accordance with whether or not an output unit configured to output the first data in the terminal of the second user is worn by the second user.

(5)

The information processing apparatus according to (2),

in which whether or not the second user is in a state where the second user can perceive the result of output is detected in accordance with whether or not the terminal of the second user is connected to a same network as the terminal of the first user.

(6)

The information processing apparatus according to (2),

in which whether or not the second user is in a state where the second user can perceive the result of output is detected on the basis of a result of behavior recognition of the second user.

(7)

The information processing apparatus according to (2),

in which whether or not the second user is pin a state where the second user can perceive the result of output is detected in accordance with whether or not the terminal of the second user is grasped, touched or looked at by the second user.

(8)

The information processing apparatus according to any one of (2) to (7),

in which the control unit performs control such that information indicating whether or not the second user is in a state where the second user can perceive the result of output is output from the terminal of the first user.

(9)

The information processing apparatus according to any one of (2) to (8),

in which, in the case where the second user is not in a state where the second user can perceive the result of output, the control unit causes a predetermined storage region to store the first data transmitted from the terminal of the first user.

(10)

The information processing apparatus according to (9),

in which, within a predetermined period after the first data is stored in the storage region, the control unit causes a data detecting unit of the terminal of the second user to be activated and causes the terminal of the first user to output second data acquired from the data detecting unit.

(11)

The information processing apparatus according to (9) or (10),

in which, in the case where the second user is put into a state where the second user can perceive the result of output, the control unit causes the first data to be extracted from the storage region and causes the terminal of the second user to output the first data.

(12)

The information processing apparatus according to any one of (2) to (8),

in which, in the case where the second user is in a state where the second user can perceive the result of output, the control unit causes the terminal of the second user to output the first data.

(13)

The information processing apparatus according to (12),

in which, in the case where the second user is in a state where the second user can perceive the result of output, the control unit causes a predetermined storage region to store the first data transmitted from the terminal of the first user.

(14)

The information processing apparatus according to (9) or (13),

in which, in the case where a predetermined deletion condition is satisfied, the control unit deletes the first data stored in the storage region.

(15)

The information processing apparatus according to (9) or (13),

in which, when a predetermined history confirmation trigger is detected, the control unit causes the terminal of the second user to output predetermined history data which is stored in the storage region and which is recognized from transmission/reception data between the terminal of the first user and the terminal of the second user.

(16)

The information processing apparatus according to any one of (1) to (15),

in which, in the case where a data detecting unit is activated in the terminal of the first user, the control unit performs control such that the first data acquired from the data detecting unit is transmitted from the terminal of the first user.

(17)

The information processing apparatus according to any one of (1) to (16),

in which the control unit controls whether or not to delay output at the terminal of the second user in accordance with a degree of importance of the first data.

(18)

The information processing apparatus according to any one of (1) to (17),

in which the first data transmitted from the terminal of the first user includes at least any one of sound data and haptic/tactile data.

(19)

An information processing method including:

controlling whether or not to perform delay processing of delaying output at a terminal of a second user executed on the basis of first data transmitted from a terminal of a first user, on the basis of a result of situation sensing with respect to the second user.

(20)

A program causing a computer to function as an information processing apparatus including:

an output control unit configured to control whether or not to perform delay processing of delaying output of first data transmitted from a terminal of a first user at a terminal of a second user, on the basis of a result of situation sensing with respect to the second user.

### REFERENCE SIGNS LIST

1 information processing system
10 information processing apparatus
130 control unit
131 detection result acquiring unit
132 output control unit
140 storage unit
150 communication unit
21 recognizing apparatus
22 analyzing apparatus
60 network
70 terminal

1. An information processing apparatus comprising:
a control unit configured to control whether or not to perform delay processing of delaying output at a terminal of a second user executed on the basis of first data transmitted from a terminal of a first user, on the basis of a result of situation sensing with respect to the second user.

2. The information processing apparatus according to claim 1,
wherein the situation sensing includes sensing of whether or not the second user is in a state where the second user can perceive a result of output at the terminal of the second user executed on the basis of the first data.

3. The information processing apparatus according to claim 2,
wherein whether or not the second user is in a state where the second user can perceive the result of output is detected in accordance with whether or not an output unit configured to output the first data in the terminal of the second user is activated.

4. The information processing apparatus according to claim 2,
wherein whether or not the second user is in a state where the second user can perceive the result of output is detected in accordance with whether or not an output unit configured to output the first data in the terminal of the second user is worn by the second user.

5. The information processing apparatus according to claim 2,
wherein whether or not the second user is in a state where the second user can perceive the result of output is detected in accordance with whether or not the terminal of the second user is connected to a same network as the terminal of the first user.

6. The information processing apparatus according to claim 2,
wherein whether or not the second user is in a state where the second user can perceive the result of output is detected on the basis of a result of behavior recognition of the second user.

7. The information processing apparatus according to claim 2,
wherein whether or not the second user is pin a state where the second user can perceive the result of output is detected in accordance with whether or not the terminal of the second user is grasped, touched or looked at by the second user.

8. The information processing apparatus according to claim 2,
wherein the control unit performs control such that information indicating whether or not the second user is in a state where the second user can perceive the result of output is output from the terminal of the first user.

9. The information processing apparatus according to claim 2,
wherein, in the case where the second user is not in a state where the second user can perceive the result of output, the control unit causes a predetermined storage region to store the first data transmitted from the terminal of the first user.

10. The information processing apparatus according to claim 9,
wherein, within a predetermined period after the first data is stored in the storage region, the control unit causes a data detecting unit of the terminal of the second user to be activated and causes the terminal of the first user to output second data acquired from the data detecting unit.

11. The information processing apparatus according to claim 9,
wherein, in the case where the second user is put into a state where the second user can perceive the result of output, the control unit causes the first data to be extracted from the storage region and causes the terminal of the second user to output the first data.

12. The information processing apparatus according to claim 2,
wherein, in the case where the second user is in a state where the second user can perceive the result of output, the control unit causes the terminal of the second user to output the first data.

13. The information processing apparatus according to claim 12,
wherein, in the case where the second user is in a state where the second user can perceive the result of output, the control unit causes a predetermined storage region to store the first data transmitted from the terminal of the first user.

14. The information processing apparatus according to claim 9,
wherein, in the case where a predetermined deletion condition is satisfied, the control unit deletes the first data stored in the storage region.

15. The information processing apparatus according to claim 9,
wherein, when a predetermined history confirmation trigger is detected, the control unit causes the terminal of the second user to output predetermined history data which is stored in the storage region and which is recognized from transmission/reception data between the terminal of the first user and the terminal of the second user.

16. The information processing apparatus according to claim 1,
wherein, in the case where a data detecting unit is activated in the terminal of the first user, the control unit performs control such that the first data acquired from the data detecting unit is transmitted from the terminal of the first user.

17. The information processing apparatus according to claim 1,
wherein the control unit controls whether or not to delay output at the terminal of the second user in accordance with a degree of importance of the first data.

18. The information processing apparatus according to claim 1,
wherein the first data transmitted from the terminal of the first user includes at least any one of sound data and haptic/tactile data.

19. An information processing method comprising:
controlling whether or not to perform delay processing of delaying output at a terminal of a second user executed on the basis of first data transmitted from a terminal of a first user, on the basis of a result of situation sensing with respect to the second user.

20. A program causing a computer to function as an information processing apparatus comprising:
a control unit configured to control whether or not to perform delay processing of delaying output at a terminal of a second user executed on the basis of first data transmitted from a terminal of a first user, on the basis of a result of situation sensing with respect to the second user.
